(19) United States
(12) Patent Application Publication
(10) Pub. No.: US 2025/0310261 A1
(43) Pub. Date: Oct. 2, 2025

(54) CENTRALIZED CONGESTION HANDLING IN A STORAGE AREA NETWORK

(71) Applicant: DELL PRODUCTS L.P., Round Rock, TX (US)

(72) Inventors: James SALVADORE, Amherst, NH (US); Erik SMITH, Douglas, MA (US); Arieh DON, Newton, MA (US); Claudio DESANTI, Santa Cruz, CA (US)

(73) Assignee: DELL PRODUCTS L.P., Round Rock, TX (US)

(21) Appl. No.: 18/624,074

(22) Filed: Apr. 1, 2024

(51) Int. Cl. H04L 47/122; H04L 43/106; H04L 47/11; H04L 67/1097

(52) U.S. Cl. CPC H04L 47/122; H04L 43/106; H04L 47/115; H04L 67/1097

(57) ABSTRACT

Network should operate efficiently and deliver the required performance levels, even during periods of high network congestion. Embodiments herein can timely provide notifications related to congestion. Embodiments herein provide a centralized congestion notification infrastructure in which a congestion indicator is enabled on the switch infrastructure and is not dependent upon whether the endpoints support or are being properly configured for congestion indicators. In one or more embodiments, a centralized discovery controller (CDC) that operates in conjunction with a telemetry stream listener service (which may be embedded in the CDC) provides centralized congestion-related notifications to endpoints in a fabric.

### BACKGROUND

### A. Technical Field

The present disclosure relates generally to information handling systems. More particularly, the present disclosure relates to reducing network congestion in Ethernet storage area networks (SANs).

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Network congestion refers to a situation where the demand for network resources, such as bandwidth or processing capacity, exceeds the available capacity of the network infrastructure or a part of the network infrastructure. This situation most often occurs when the incoming data flowing into the network (or a device in the network) is exceeding the rate at which data is exiting the network (or the device in the network). In the context of storage area networks (SANs), network congestion can have several negative impacts, including increased latency, data loss, and reduced performance.

Currently, there is no effective solution for congestion mitigation in nonvolatile memory express (NVMe) SANs, particularly NVMe/TCP SANs. While some congestion mitigation mechanisms—like Explicit Congestion Notification (ECN), which is an extension to the TCP/IP protocol suite that enables congestion notification between network devices—exist for Ethernet fabrics, there are problems implementing such a mechanism for NVMe/TCP SANs. For example, not all endpoints (e.g., hosts and storage arrays/storage subsystems) support ECN. This inconsistent support for ECN makes implementing ECN in a TCP/IP fabric a daunting task.

Accordingly, it is highly desirable to find new ways to handle congestion in storage area networks, like NVMe/TCP SANs.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 depicts a storage area network (SAN) environment with a centralized discovery controller, according to embodiments of the present disclosure.

FIG. 2 depicts a system for centralizing congestion notification, according to embodiments of the present disclosure.

FIG. 3A and FIG. 3B depict a methodology for handling a congestion notification or notifications, according to embodiments of the present disclosure.

FIG. 4 depicts a methodology for handling a cleared congestion notification or notifications, according to embodiments of the present disclosure.

FIG. 5 depicts a simplified block diagram of an information handling system, according to embodiments of the present disclosure.

FIG. 6 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall also be noted that although embodiments described herein may be within the context of NVMe/TCP networks, aspects of the present disclosure are not so limited. Accordingly, the aspects of the present disclosure may be applied or adapted for use in other contexts.

### A. General Background

Network congestion refers to a situation where the demand for network resources, such as bandwidth or processing capacity, exceeds the available capacity of the network infrastructure or a part of the network infrastructure. This situation most often occurs when the incoming data flowing into the network (or a device in the network) is exceeding the rate at which data is exiting the network (or the device in the network). In the context of storage area networks (SANs), network congestion can have several negative impacts, including but not limited to:

Increased latency: As congestion occurs and a network resource or resources become overwhelmed, the time it takes for data to travel from the source to the destination increases. This increased latency can disrupt real-time applications, such as database transactions or video streaming, which require timely delivery of data.

Packet loss: When a network is congested, it may not have enough capacity to handle all the incoming data packets. As a result, packets may be dropped or lost, leading to incomplete or corrupted data transmission. This can negatively affect the integrity and reliability of the network to transmit data.

Reduced throughput: Congestion can limit the overall throughput or data transfer rate of the SAN. This means that the SAN may not be able to utilize its full bandwidth capacity, leading to suboptimal performance and slower data access.

To mitigate the impact of network congestion on storage area networks, various techniques are employed. The specific mitigation strategies depend on the underlying network technologies and protocols used by each SAN type.

Fibre Channel (FC) SANs use buffer-to-buffer (B2B) flow control as a primary mechanism to regulate the amount of data that can be transmitted between sending and receiving devices. In Fibre Channel, buffer credits are used to prevent buffer overrun. Each networking information handling system (e.g., a switch or router) and device in the Fibre Channel fabric has a certain number of buffer credits allocated to it. When a networking information handling system transmits a frame, it consumes one buffer credit from the sender, and the sender waits until it receives a credit back (e.g., R_RDY) before sending more data. B2B credit flow control helps prevent overrun by ensuring that the sending device does not exceed the available buffer capacity of the receiving device or switch. It helps avoid packet loss and maintains reliable data transfer within the Fibre Channel SAN. B2B flow control is native to the Fibre Channel protocol. Being native to the protocol greatly helps with implementation and configuration as all standard equipment (e.g., hosts, switches/routers, and storage arrays) in the Fibre Channel network, regardless of vendor, natively supports B2B flow control.

For SAN technologies that use Transmission Control Protocol/Internet Protocol (TCP/IP) networks, such as NVMe/TCP, a primary congestion mitigation mechanism is Explicit Congestion Notification (ECN). ECN is an extension to the TCP/IP protocol suite that enables end-to-end congestion notification between network devices. Traditionally, when a network experiences congestion, switches/routers drop packets to signal the endpoints to slow down transmission. However, dropping packets can lead to unnecessary retransmissions and increased latency.

ECN provides an alternative method of signaling congestion by allowing switches/routers to flag packets with an ECN bit when the network reaches a certain threshold. By marking packets, the transmitter can reduce its transmission rate thereby avoiding packet loss. When an ECN-capable switch detects congestion, it marks the packets with the ECN bit in the IP header to indicate that congestion has been detected. The receiving endpoint of the connection can then include this ECN bit in its response to the transmitter, who would then adjust its transmission rate. By reducing the transmission rate, the endpoint can help prevent further congestion and improve overall network performance. ECN is supported and enabled by almost all modern TCP/IP switches and routers; however, support for ECN by host operating system and storage array can vary dramatically from vendor to vendor. This unreliability about whether the endpoints will support ECN makes implementing ECN in a TCP/IP fabric a daunting task for at least the following reasons:

End-to-end compatibility issues: The inconsistency in support and adoption for ECN across the various host and storage vendor platforms can create compatibility issues between various hardware endpoints and software drivers.

Increased complexity: Implementing ECN can be complex as different network equipment will have specific implementation methods and management software control points.

For ECN to be effective, it ideally should be implemented end-to-end across the entire network path, from the sender to the receiver. While it may be possible to implement ECN at individual switches within the network, partial or limited deployment particularly at the host and storage array endpoints can greatly limit the capability of ECN as a congestion mitigation mechanism. Thus, a partial implementation can have particularly negative impacts for storage transport protocols such NVMe/TCP, which rely on stable and low latency TCP/IP network.

Ensuring that NVMe/TCP SANs can operate efficiently and deliver the required performance levels-even during periods of high network congestion-minimally requires that the switch infrastructure be able to provide timely notification to the NVMe/TCP endpoints (e.g., hosts and storage arrays) that a congestion event is occurring. If it cannot be guaranteed that the NVMe/TCP endpoints will support ECN, then alternative centralized congestion notification methods must be found in which ECN is enabled on at least just the switch infrastructure/fabric.

Accordingly, it is highly desirable to find new ways to handle congestion in storage area networks, like NVMe/TCP SANs.

### B. Systems and Methods Embodiments

To address the congestion issue in storage area networks, like NVMe/TCP SANS, embodiments create a centralized congestion notification solution for NVMe/TCP SANs.

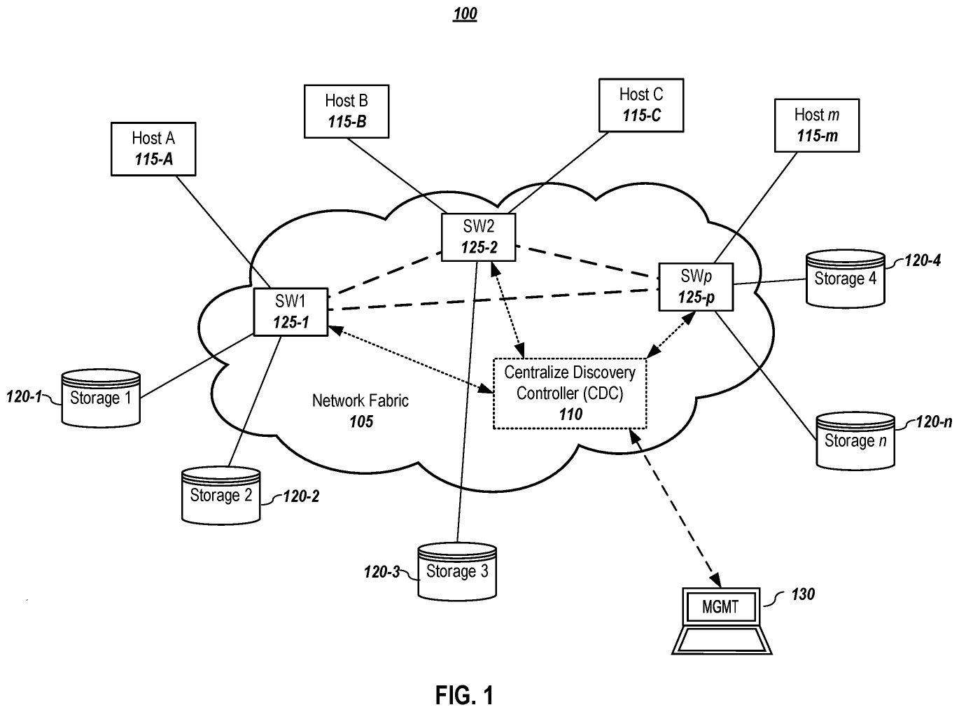

FIG. 1 depicts a TCP/IP storage area network (SAN) environment, according to embodiments of the present disclosure. Depicted is the SAN environment 100 that includes a network fabric 105 comprising a plurality of networking information handling systems (e.g., switches 1-p 125) and a centralized discovery controller (CDC) 110 within the network fabric 105. The CDC 110 may operate on a single information handling system or may be distributed to a set of information handling systems. For example, in one or more embodiments, different CDC services may be distributed across different information handling systems within the fabric 105.

In the depicted embodiment there are a plurality of host systems, host A 115-A, through host m 115-m, and there is a plurality of storage subsystems (e.g., storage array 1 120-1 through storage array n 120-n). The host systems and the storage arrays may also be referred to as endpoints or endpoint systems. In one or more embodiments, one or more of the endpoints may be nonvolatile memory express (NVMe) entities. NVMe is a protocol designed for accessing storage media connected through a bus (e.g., via a PCIe (Peripheral Component Interconnect Express) bus).

In one or more embodiments, the endpoints may register with the CDC, which may be performed as part of a registration process or discovery and registration process. For example, in one or more embodiments, a push registration may involve an endpoint causing its information to be sent and registered with the CDC, and a pull registration may involve the CDC discovering and retrieving an endpoint's information. It shall be noted that a number of different discovery and registration processes may be utilized in embodiments herein.

Note that in the depicted embodiment, the fabric 105 may comprise a number of interconnected networking information handling systems (e.g., switches and/or routers). For example, FIG. 1 shows, for sake of illustration of embodiments herein, that host A 115-A connects to the fabric 105 via switch 1 125-1, and host m 115-m connects to the fabric 105 via switch p 125-p.

In one or more embodiments, the CDC may maintain one or more datastores/databases of information related to the endpoints and their management. For example, zoning information may be defined in a nameserver (or zone) database (not depicted) and may be maintained by the CDC. In one or more embodiments, a zone (which may also be referred to as a zone group) is a unit of activation (i.e., a set of access control rules enforceable by the CDC). Once in a zone, the interfaces of endpoints (which may be referred to as zone members) are able to communicate with one another when the zone has been added to an active zone set of the nameserver database. Zones may be created for a number of reasons, including to increase network security, and to prevent data loss or data corruption by controlling access between devices or user groups.

In the depicted embodiment of FIG. 1, the CDC is communicatively coupled to each of the network information handling systems (e.g., switch SW1 125-1 through switch SWp 125-p) and can obtain information from the switches. Also depicted in FIG. 1 is a management interface 130, which allows an administrator to access the CDC for various purposes such as configuration and management. The CDC is a discovery mechanism that an endpoint may use for various communications mechanisms and services. For example, a host may use the CDC to discover a list of nonvolatile memory (NVM) storage subsystems with namespaces that are accessible to that host. Or, for example, a subsystem may use the CDC to discover a list of nonvolatile memory express (NVMe) enabled-hosts that are on/connected to the fabric.

In one or more embodiments, a CDC may support all the functions of a discovery controller on the storage subsystems on the fabric, along with its own discovery log that collects data about the hosts and subsystems on the fabric. Also, the CDC may act as broker for the communication between endpoints and may act as a central point for communications from endpoints, networking information handling systems, or both.

In one or more embodiments, two primary components help facilitate the congestion notification: (1) a networking information handling system infrastructure (e.g., switches and/or routers) infrastructure which has both ECN and a telemetry stream sender service enabled on the networking information handling systems; and (2) an NVMe/TCP centralized discovery controller (CDC) with a telemetry stream listener service enabled. Each of these components are discussed in more detail below.

1. Networking Information Handling System Infrastructure with Both Explicit Congestion Notifications (ECN) and a Telemetry Stream Sender Service Enabled.

In one or more embodiments, a switch infrastructure which has both ECN and a telemetry stream sender service enabled. As discussed above, ECN allows switches/routers to provide explicit congestion notification through packet marking. To be useful, in one or more embodiments, this ECN data is packaged and transmitted to a central location (e.g., a listener service) for monitoring, processing, and/or analysis. In one or more embodiments, the data may be transmitted in a continuous flow or may be sent based upon one or more triggers (e.g., a congestion event, according to a schedule, a new connection/data flow, a change in a connection/data flow, by request, etc.). This data may be referred to as a telemetry stream. A telemetry stream service commonly used in TCP/IP networks is Sampled Flow (sFlow). sFlow is a telemetry stream service technology that monitors, collects, and analyzes network data, and that is supported by most modern network information handling system hardware. This telemetry data may be used to provide insights into network usage, performance, and issues (such as, but not limited to, network congestion).

In one or more embodiments, a sender service may be enabled on a switch/router infrastructure and may prepare data by performing one or more of the following functions:

Packet Sampling: In one or more embodiments, the sender service may select a representative subset of network packets for analysis. One or more sampling techniques may be employed, including but not limited to random sampling, regular sampling, deterministic sampling, etc., to ensure a representative sample of network traffic.

Traffic Data Collection: In one or more embodiments, the sender service collects data from the sampled packets. The collected information may include information such as packet headers (including whether an ECN bit has been set), counters, timestamps, and other relevant metrics. This data is typically collected at high-speed rates to capture a comprehensive view of network activity.

Datagram Generation: After collecting the traffic data, in one or more embodiments, the sender service may encapsulate this information into one or more datagrams. These datagrams may be formatted according to an underlying fabric protocol specifications, which define the structure and contents of the data to be transmitted. Alternatively, the data encapsulation and formatting may be specific for the sender-listener configuration.

Exporting Datagrams: The sender service may then transmit the generated data to one or more designated telemetry stream listeners (or collectors) in the network fabric. In one or more embodiments, the sender may send the datagrams using UDP (User Datagram Protocol) or using a different transport protocol, such as SCTP (Stream Control Transmission Protocol).

2. Centralized Discovery Controller (CDC) with a Telemetry Stream Listener Service Enabled.

An NVMe/TCP centralized discovery controller (CDC) may operate with or be embedded with a telemetry stream listener service that is enabled. The listener service may be embedded with the CDC or may be separate but operate in conjunction with the CDC. In one or more embodiments, the NVMe/TCP CDC may be a network service that is responsible for discovering and automating the connectivity between NVMe/TCP devices in a centralized manner. NVMe/TCP is typically used in large enterprise networks, data centers, or cloud environments where there are many network devices and endpoints that need to be managed.

In one or more embodiments, the CDC maintains a real-time map of the network topology, including endpoint (i.e., initiators (e.g., hosts) and target (e.g., storage subsystems/storage arrays)) NVMe Qualified Names (NON), Internet Protocol (IP) addresses, device type, Media Access Control (MAC) addresses, and other relevant information. The CDC provides several benefits to network administrators and engineers, such as simplifying the management and troubleshooting of the network by providing a centralized view of the network topology and device locations. The CDC also enables network automation and orchestration by providing a single point of control for network devices by sending notifications (e.g., Asynchronous Event Notifications (AENs)) about fabric events to the registered endpoints. For example, a notification may be sent related to a new host logging into the network.

CDC embodiments herein may comprise functionality of a listener service (e.g., an embedded telemetry flow listener service) or may operate in conjunction with a listener service. In one or more embodiments, the listener service may comprise several functions including but not limited to the following.

Datagram Reception: The listener service may listen on a specific port for incoming datagrams from a sender service enabled on a switch in the network fabric.

Data Parsing and Analysis: Upon receiving the datagrams, the listener service may extract the encapsulated traffic data. It may also parse the datagrams, decode the information contained within, and perform analysis on the received data.

Traffic Monitoring and Reporting: The listener service may process the traffic data to provide insights into network behavior, performance, and security. It may generate various reports, metrics, or visualizations to help network administrators monitor and troubleshoot the network. This information may be accessed through a CDC graphical user interface, Redfish/REST API interface, and/or through Simple Networking Management Protocol (SNMP). Redfish is an industry-standard REST API (Representational State Transfer Application Programming Interface), which is an architectural style for designing networked applications that different network equipment may use.

Congestion-Related Notifications: In one or more embodiments, the CDC may be configured to send congestion notifications to, for example, the source and destination IP addresses. For example, if the embedded listener discovers that during its analysis of a received datagram packet that it has an ECN bit set (which indicates congestion is present), the CDC may be triggered to send a congestion alert (e.g., an AEN) to the source and/or destination devices IP addresses contained within the datagram packet. In one or more embodiments, the CDC may also notify all other in-zone members peer members of the source and destination devices. That is, each zone member for each zone that includes, depending upon implementation, either the source device, destination device, or both may also be notified because the congested device may affect devices for each zone the congested device is a member of. To help facilitate notification, devices may be required to be registered with the CDC, which may occur as part of an initialization process for the connecting to the fabric. In one or more embodiments, one or more new types of notification may be utilized—e.g., a congestion AEN and a congestion cleared AEN.

Integration with Network Management Systems: In one or more embodiments, the listener service may interface with network management systems or other monitoring tools events (e.g., SNMP). Such implementations allow for consolidated visibility and comprehensive network analysis.

### 3. Example System Implementation Embodiments

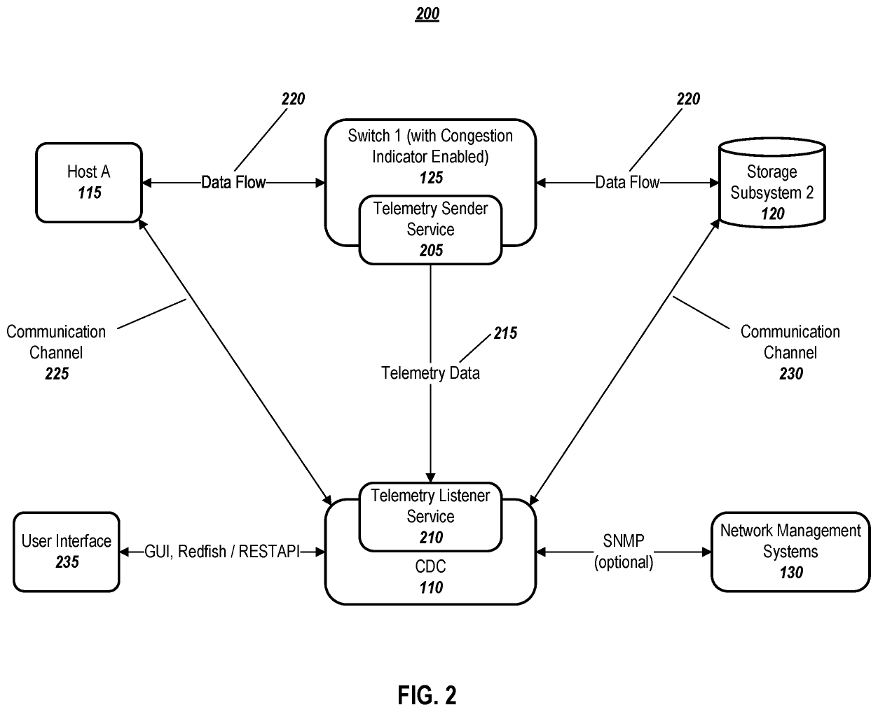

FIG. 2 depicts a system for centralizing congestion notification including various components and their interconnections with each other, according to embodiments of the present disclosure. In one or more embodiments, networking information handling systems (e.g., switches/routers) of a network fabric comprise or operate in conjunction with a telemetry sender service 205 that communicates with a telemetry listener service 210 of a CDC 110. FIG. 2 depicts an example switch 125 that is configured with congestion indication enabled (e.g., supports ECN) and with a telemetry sender service 205. The switch facilitates a data flow 220 between an initiator (e.g., host A 115) and a target (e.g., storage subsystem 120). If the switch 125 detects congestion related to this data flow 220, it can mark a congestion indicator in data 215 that is sent via the telemetry sender service 205 to a telemetry listener service 210 of the CDC 110. Note that this data 215 may be a continuous stream of data or may be data communicated based upon one or more triggers (e.g., a congestion event, according to a schedule, a new connection/data flow, a change in a connection/data flow, by request, etc.).

As will be described in the next section, the CDC, upon recognizing the congestion indicator in the telemetry data 215, may notify one or more relevant entities. For example, the CDC may notify the endpoints (e.g., host A 115 and storage array 120) involved in the congested data flow 220 via communication channels 225, 230, respectively, of the congestion so that one or both of the endpoints may take one or more remedial actions.

Also depicted in FIG. 2, the CDC 110 may include one or more interfaces for users or systems (e.g., user interface 235 and network management system interface 130). One or more of the interfaces may be used to display data (e.g., a dashboard reporting the status of aspects of the network, such as congestion) and may be used by an administrator or user to effect a change to one or more devices in the network.

### 4. Example Method Embodiments

In one or more embodiments, the CDC may serve as more than just a discovery controller, but may also act as a central point to maintain and distribute congestion-related notifications. Given its central position, the CDC may serve as an “orchestrator” for congestions notifications/reporting—providing a single control point, which significantly reduces compatibility and complexity issues when implementing NVMe/TCP SANs congestion monitoring and mitigation control.

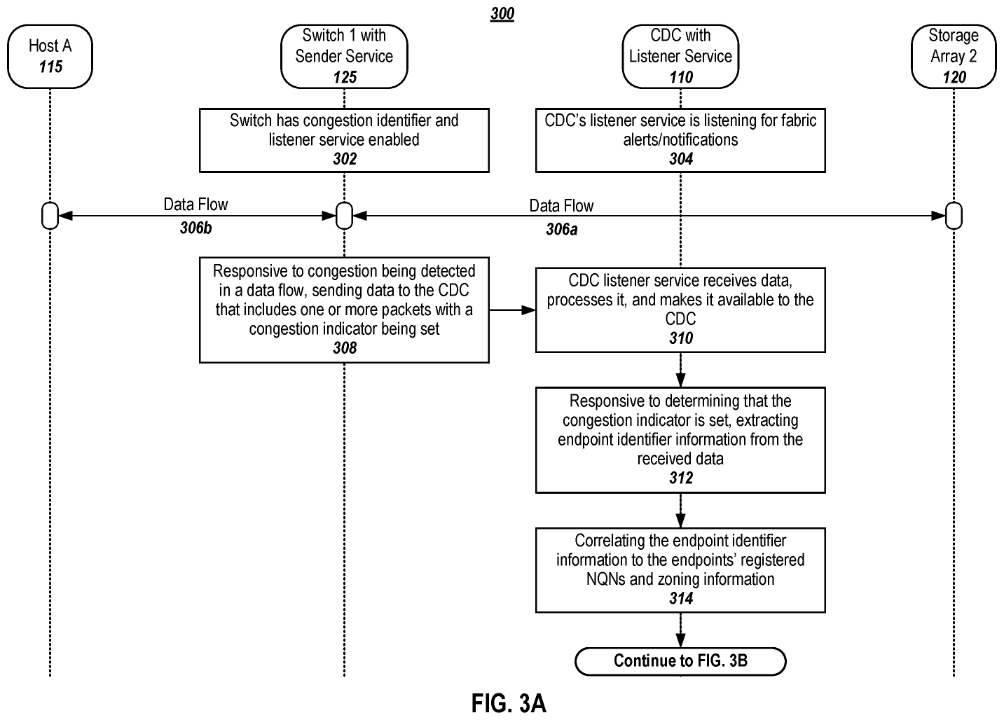

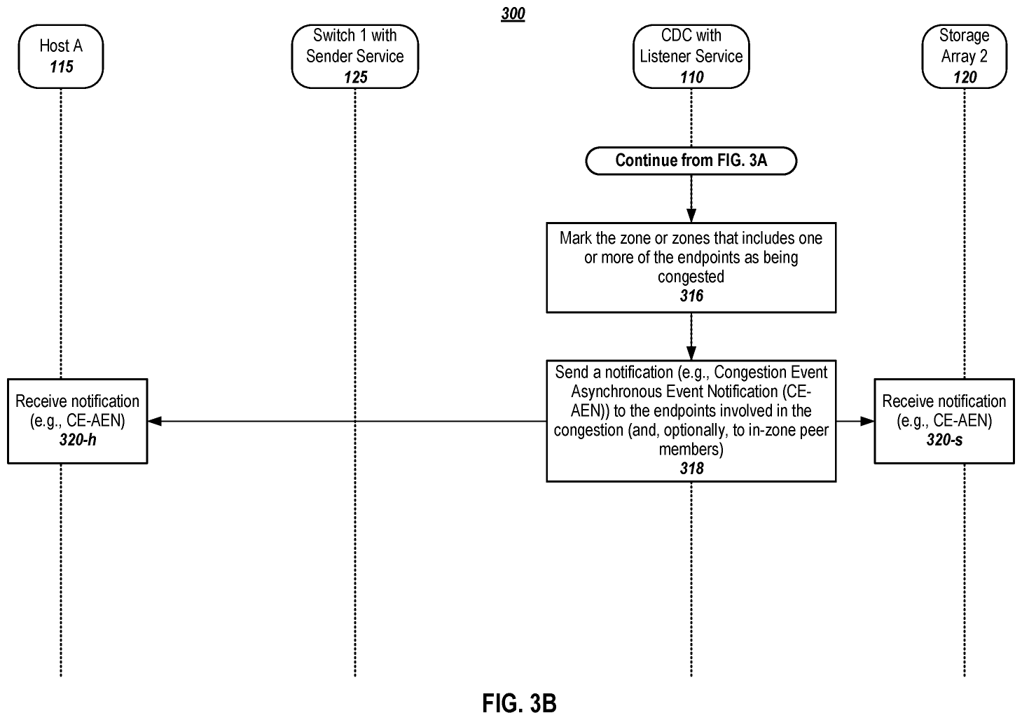

FIG. 3A and FIG. 3B depict a methodology for handling congestion notification, according to embodiments of the present disclosure. Embodiments comprise networking information handling systems (e.g., switch 125) that are enabled (302) with congestion indication services (e.g., ECN-enabled) and with a telemetry sender service. Embodiments also comprise a CDC 110 with a telemetry listener service enabled (304) and is listening for alerts/notifications from switches in the fabric (e.g., network fabric 105 in FIG. 1).

For sake of illustration, assume a data flow 306 between two endpoints, host A 115 and storage array 2 120. Because the data flow 306 is via switch 1 125, the switch may monitor the data flow for issues, such as congestion. Responsive to congestion being detected in the data flow, the switch may send (308) data to the CDC that includes one or more packets with a congestion indicator set. For example, upon the switch 125 detecting congestion in the data flow 306, it marks an ECN bit in one or more packet headers. In one or more embodiments, the sender service creates one or more datagrams related to the data flow 306 and sends (308) this data which includes packets with the ECN bit set-via broadcast to the CDC 110.

In one or more embodiments, the CDC's listener service (e.g., a sFlow listener) receives the data, processes it, and makes (310) at least some of the data available to the CDC. In one or more embodiments, the CDC may use some of the data to update any relevant dashboards in a CDC graphical user interface (e.g., in a dashboard viewable via user interface 235 and/or network management system 130 in FIG. 2).

Responsive to determining that the congestion indicator (e.g., ECN bit) is set within the data, the CDC may extract (312) endpoint identifier information from the received data. In one or more embodiments, the CDC/CDC listener service may extract one or more of the following information from a packet in the data: initiator IP Address, target IP addresses, MAC address(es), virtual local area network (VLAN) information, and ports (particularly switch ports) involved in the data flow that experienced the congestion event. Additional data may also be extracted, including but not limited to, the volume and rate of the offending data flow, timestamps identifying when the issue occurred, and how long it has been ongoing, etc.

In one or more embodiments, the listener service may pass some or all of this information to the CDC, and the CDC may use the initiator identifier information (e.g., host IP address) and/or target identifier information (e.g., storage array IP address) to correlate (314) one or more of the endpoints' identifier information to the endpoint's corresponding registered NON(s) and zoning information. That is, in one or more embodiments, for the host, the storage array, or both, the CDC correlates at least one of the one or more identifiers to any zones of which the corresponding host, storage array, or both are members and may mark (316) the identified zone or zones as being congested. The CDC may mark (316) the associated zone or zones as congested by attaching a congestion flag to the zone or zones in a zoning database.

As depicted in FIG. 3B, the CDC may send (318) a notification (e.g., a Congestion Event Asynchronous Event Notification (CE-AEN)) to the initiator endpoint, the target endpoint, or both who are involved in the congestion. Note that the CE-AEN may include the identifier information (e.g., NQNs, IP Addresses, etc.) as to which device or devices are the source of the congestion. Alternatively, in response to the notification, the endpoint device may issue a request (e.g., a get log page request) to obtain the information from the CDC via a response (e.g., a log page response) to that request. In either case, one or more of the endpoints receives 320 the notification of congestion.

While not depicted, one or both of the endpoints may take one or more actions related to the congestion. For example, if the issue is that the storage array 120 is sending too much data via the data flow 306 to the host 115, the storage array may reduce the data rate or suspend (e.g., temporarily suspend) send data to ameliorate the congestion issue.

In one or more embodiments, the CDC may also notify one or more of their in-zone peer members. The zone members may also take one or more actions related to the congestion. For example, if a storage array is in the same or a different zone than storage array 2 120 that is sending data to the same host (i.e., host A 115), that storage array may reduce its data rate or suspend sending data to that host until the congestion indicator is cleared.

Note that, in one or more embodiments, the correlation to zone or zones and notification of zone members may be done relative to only one endpoint. For example, if the cause of the congestion event is that the host is not able to keep up with the data rate of data being supplied to it from the storage array, the CDC may identify only those zones to which the host is a member and then notify the in-zone members or a subset thereof (i.e., the storage arrays). In this way, the storage arrays from the zone or zones may throttle/moderate their data flows to the host to avoid adding to the congestion issue.

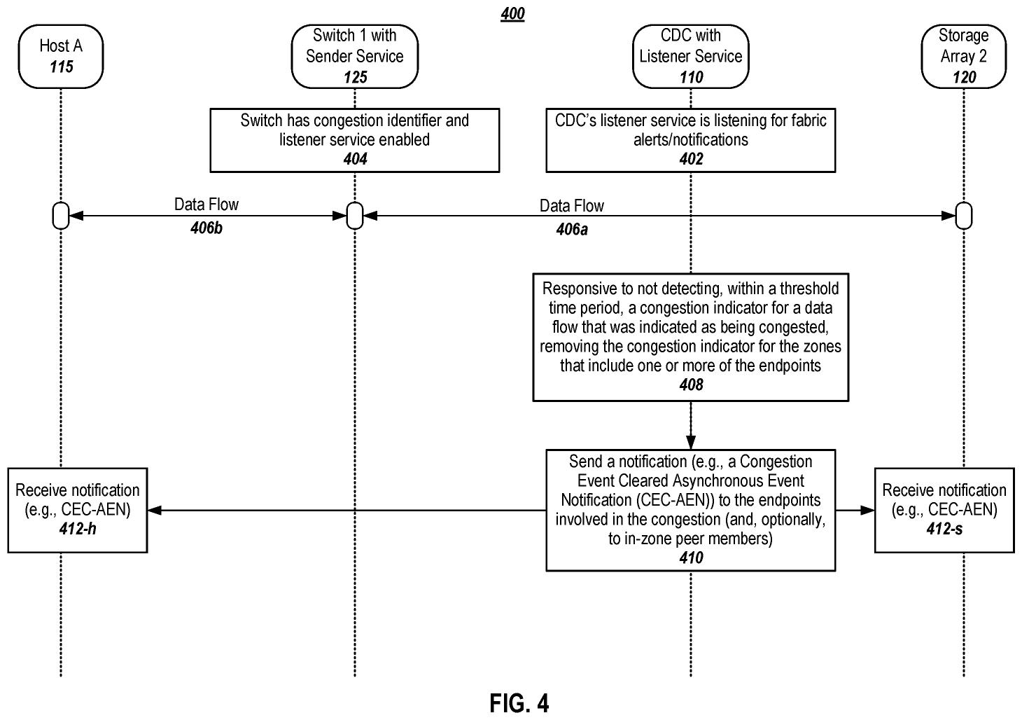

In addition to handling detection and notification of congestion within the network fabric, embodiments may also help identify when congestion has been cleared and may similarly notify relevant entities. FIG. 4 depicts a methodology for handling when congestion is cleared, according to embodiments of the present disclosure. In similar manner as with FIGS. 3A and 3B, embodiments comprise networking information handling systems (e.g., switch 125) that are enabled (404) with congestion indication services (e.g., ECN-enabled) and with a telemetry sender service and a CDC with a telemetry listener service enabled (402) and is listening for alerts/notifications from switches in the fabric.

Assume, for sake of illustration, that a congestion event of a data flow 406 has occurred, been detected, and handled (e.g., such as described above). Also assume, for sake of illustration, that the congestion of the data flow 406 has been resolved. In one or more embodiments, the telemetry sender service may send a “congestion cleared” notification. Alternatively, or additionally, the telemetry sender service may, once the congestion has been cleared, may no longer mark packets with a congestion indicator (e.g., no longer mark packet(s) with an ECN bit set). In one or more embodiments, responsive to the CDC not detecting, within a threshold time period (e.g., 300 seconds or some other threshold level), a congestion indicator for a data flow that was previously indicated as being congested, the CDC may remove (408) the congestion indicator for the zone or zones that were previously marked as being congested due to a congestion event for that data flow 406. For example, the listener service of the CDC may prompt the CDC to remove a congestion flag in a database for the zone or zones that were previously flagged as congested due to the congestion event for the data flow 406. Note that clearing of a congestion flag for a zone does not mean that there are no other congestion flags for the zone. One or more other zone members may separately be experiencing congestion, which would result in a congestion flag for the zone. The flag, or associated data, may include the source of the congestion and/or other affected devices. Given this information, in one or more embodiments, non-affected zone members may operate as if there were no flag indicator.

In one or more embodiments, the CDC may also send (410) a notification (e.g., a Congestion Event Cleared Asynchronous Event Notification (CEC-AEN)) to one or more of the endpoints involved in the congestion (and, optionally, to in-zone peer members). Note that the CEC-AEN may include the identifier information (e.g., NQNs, IP Addresses, etc.) as to which device or devices are related to the cleared congestion. Alternatively, in response to the notification, the endpoint device may issue a request (e.g., a get log page request) to obtain the information from the CDC via a response (e.g., a log page response) to that request. In either case, one or more of the endpoints receives the notification of congestion. Note that, in one or more embodiments, the CE-AEN and CEC-AEN may be the same or similar notifications with different information provided (e.g., congestion vs. congestion cleared), or may be the same and the response to a get log page provides information regarding whether it is a congestion notification or a congestion cleared notification.

In one or more embodiments, after the one or more of the endpoints receive (412) the notification that the congestion is cleared, one or both of the endpoints may take one or more actions related to the cleared congestion. For example, the storage array 120 may begin to increase its data flow rate to the host 115, the storage array may remove a suspension (e.g., lift a temporary suspension) on sending data to the host, etc.

Thus, as illustrated by the example methods discussed above, a CDC in conjunction with a telemetry listener service facilitates a centralized congestion-related notification mechanism for NVMe/TCP fabrics. Currently, no such centralized network congestion offerings exist for NVMe/TCP fabrics.

One skilled in the art shall recognize a number of benefits of embodiments. For example, the congestion indicator functionality (e.g., ECN) only needs to be enabled and configured on the switch infrastructure, which removes the dependency of the endpoints needing to support and be configured properly for congestion indicator functionality. Also, storage administrators can be notified of congestion events as they happen, and they can be made aware of which IP addresses (and the associated NQNs) are involved in the congestion. This information greatly helps in troubleshooting the congestion, allows for quicker fault isolation, and facilitates faster resolution of the issue.

Switch infrastructure preferably should be able to provide timely notification to the NVMe/TCP endpoints and storage administrators that a congestion event is occurring to ensure that NVMe/TCP SANs can operate efficiently and deliver the required performance levels, even during periods of high network congestion. Embodiments herein provide a centralized congestion notification infrastructure in which a congestion functionality (e.g., ECN) is enabled on the switch infrastructure and is not dependent upon whether the endpoints support or are being properly configured for congestion indicators. In one or more embodiments, a CDC that operates in conjunction with a telemetry stream listener service provides centralized congestion-related notifications to endpoints in NVMe/TCP fabrics.

### C. Information Handling System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

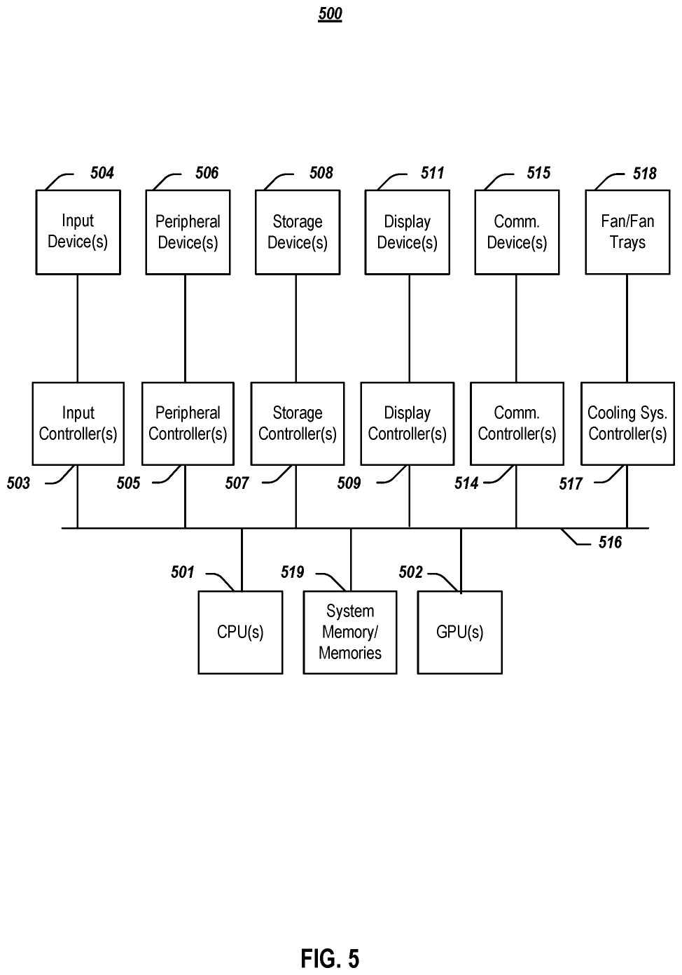

FIG. 5 depicts a simplified block diagram of an information handling system (or computing system), according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more CPUs 501 that provides computing resources and controls the computer. CPU 501 may be implemented with a microprocessor or the like and may also include one or more graphics processing units (GPU) 502 and/or a floating-point coprocessor for mathematical computations. In one or more embodiments, one or more GPUs 502 may be incorporated within the display controller 509, such as part of a graphics card or cards. The system 500 may also include a system memory 519, which may comprise RAM, ROM, or both.

A number of controllers and peripheral devices may also be provided, as shown in FIG. 5. An input controller 503 represents an interface to various input device(s) 504, such as a keyboard, mouse, touchscreen, stylus, microphone, camera, trackpad, display, etc. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 508 may also be used to store processed data or data to be processed in accordance with the disclosure. The system 500 may also include a display controller 509 for providing an interface to a display device 511, which may be a cathode ray tube (CRT) display, a thin film transistor (TFT) display, organic light-emitting diode, electroluminescent panel, plasma panel, or any other type of display. The computing system 500 may also include one or more peripheral controllers or interfaces 505 for one or more peripherals 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fibre Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 500 comprises one or more fans or fan trays 518 and a cooling subsystem controller or controllers 517 that monitors thermal temperature(s) of the system 500 (or components thereof) and operates the fans/fan trays 518 to help regulate the temperature.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

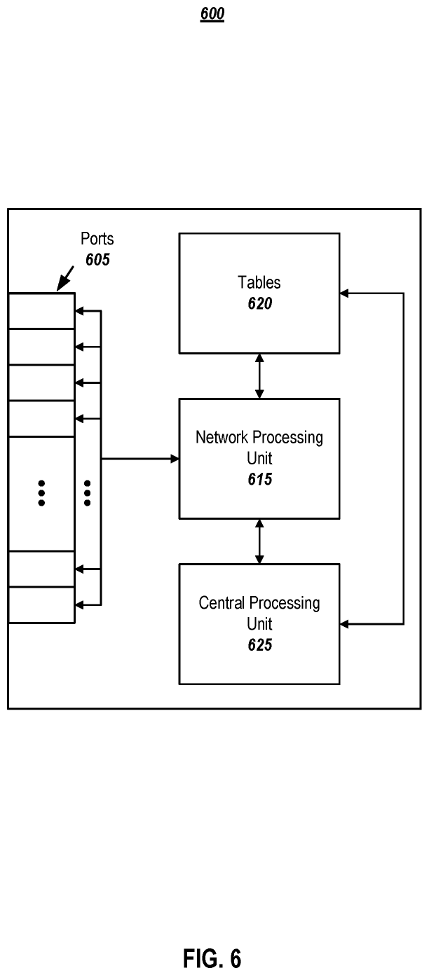

FIG. 6 depicts an alternative block diagram of an information handling system, according to embodiments of the present disclosure. It will be understood that the functionalities shown for system 600 may operate to support various embodiments of the present disclosure—although it shall be understood that such system may be differently configured and include different components, additional components, or fewer components.

The information handling system 600 may include a plurality of I/O ports 605, a network processing unit (NPU) 615, one or more tables 620, and a CPU 625. The system includes a power supply (not shown) and may also include other components, which are not shown for sake of simplicity.

In one or more embodiments, the I/O ports 605 may be connected via one or more cables to one or more other network devices or clients. The network processing unit 615 may use information included in the network data received at the node 600, as well as information stored in the tables 620, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media comprising one or more sequences of instructions, which, when executed by one or more processors or processing units, causes steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A processor-implemented method for handling congesting in a storage area network connected via a fabric, the method comprising:
responsive to a listener service of a centralized discovery controller (CDC) determining that a congestion identifier exists in data prepared by a sender service of a networking information handling system in the fabric, in which the data is related to a data flow being handled by the networking information handling system and the data flow is related to a congestion event:
extracting, from the data, one or more identifiers for a host and a storage array that are involved in the data flow;
for the host, the storage array, or both, performing at least one of:
correlating at least one of the one or more identifiers to any zones of which the host is a member;
correlating at least one of the one or more identifiers to any zones of which the storage array is a member; and
correlating at least one of the one or more identifiers to any zones of which both the host and the storage array are members;
marking the identified zones as being congested; and
sending a congestion event notification to at least one of the host and the storage array involved in the data flow that is related to the congestion event.

2. The processor-implemented method of claim 1 further comprising:
responsive to the listener service of the CDC not receiving from the sender service of the networking information handling system a congestion indicator for the data flow within a threshold time period:
removing the marking that was added to the identified zones; and
sending a congestion event cleared notification to at least one of the host and the storage array.

3. The processor-implemented method of claim 1 wherein the congestion identifier is an Explicit Congestion Notifications (ECN) indicator in a packet header in the data prepared by the sender service of the networking information handling system.

4. The processor-implemented method of claim 1 further comprising extracting from the data at least one of:
a volume and rate of the data flow which is causing congestion; and
a timestamp identifying when the congestion event occurred and for how long the congestion event has been occurring.

5. The processor-implemented method of claim 1 wherein the step of extracting, from the data, one or more identifiers for the host and the storage array that are involved in the data flow comprises:
extracting, from the data, one or more of: an Internet Protocol (IP) address, Media Access Control (MAC) address, Virtual Local Area Network (VLAN) identifier, or port for the host and the storage array.

6. The processor-implemented method of claim 1 further comprising:
sending a congestion event notification to one or more members of the identified zones.

7. The processor-implemented method of claim 1 wherein the congestion event notification or a subsequent message related to the congestion event notification includes one or more identifiers that identifies a source of the congestion event.

8. The processor-implemented method of claim 1 wherein the step of marking the identified zones as being congested comprises:
for each identified zone, adding or indicating a congestion flag to the zone in a zoning database that is maintained by the CDC.

9. The processor-implemented method of claim 1 wherein the step of correlating at least one of the one or more identifiers to any zones comprises:
correlating at least one of the one or more identifiers to a non-volatile memory express (NVMe) qualified name (NON) of a member of a zone.

10. An information handling system comprising:
one or more processors; and
a non-transitory computer-readable medium or media comprising one or more sets of instructions which, when executed by at least one of the one or more processors, causes steps to be performed comprising:
responsive to a listener service of a centralized discovery controller (CDC) determining that a congestion identifier exists in data prepared by a sender service of a networking information handling system in a fabric, in which the data is related to a data flow being handled by the networking information handling system and the data flow is related to a congestion event:
extracting, from the data, one or more identifiers for a host and a storage array that are involved in the data flow;
for the host, the storage array, or both, performing at least one of:
correlating at least one of the one or more identifiers to any zones of which the host is a member;
correlating at least one of the one or more identifiers to any zones of which the storage array is a member; and
correlating at least one of the one or more identifiers to any zones of which both the host and the storage array are members;
marking the identified zones as being congested; and
sending a congestion event notification to at least one of the host and the storage array involved in the data flow that is related to the congestion event.

11. The information handling system of claim 10 wherein the non-transitory computer-readable medium or media further comprises one or more sequences of instructions which, when executed by at least one of the one or more processors, causes steps to be performed comprising:
responsive to the listener service of the CDC not receiving from the sender service of the networking information handling system a congestion indicator for the data flow within a threshold time period:
removing the marking that was added to the identified zones; and
sending a congestion event cleared notification to at least one of the host and the storage array.

12. The information handling system of claim 10 wherein the non-transitory computer-readable medium or media further comprises one or more sequences of instructions which, when executed by at least one of the one or more processors, causes steps to be performed comprising:
sending a congestion event notification to one or more members of the identified zones.

13. The information handling system of claim 10 wherein the congestion event notification or a subsequent message related to the congestion event notification includes one or more identifiers that identifies a source of the congestion event.

14. The information handling system of claim 10 wherein the step of marking the identified zones as being congested comprises:
for each identified zone, adding or indicating a congestion flag to the zone in a zoning database that is maintained by the CDC.

15. A non-transitory computer-readable medium or media comprising one or more sequences of instructions which, when executed by at least one processor, causes steps to be performed comprising:
responsive to a listener service of a centralized discovery controller (CDC) determining that a congestion identifier exists in data prepared by a sender service of a networking information handling system in a fabric, in which the data is related to a data flow being handled by the networking information handling system and the data flow is related to a congestion event:
extracting, from the data, one or more identifiers for a host and a storage array that are involved in the data flow;
for the host, the storage array, or both, performing at least one of:
correlating at least one of the one or more identifiers to any zones of which the host is a member;
correlating at least one of the one or more identifiers to any zones of which the storage array is a member; and
correlating at least one of the one or more identifiers to any zones of which both the host and the storage array are members;
marking the identified zones as being congested; and
sending a congestion event notification to at least one of the host and the storage array involved in the data flow that is related to the congestion event.

16. The non-transitory computer-readable medium or media of claim 15 further comprising one or more sequences of instructions which, when executed by at least one processor, causes steps to be performed comprising:
responsive to the listener service of the CDC not receiving from the sender service of the networking information handling system a congestion indicator for the data flow within a threshold time period:
removing the marking that was added to the identified zones; and
sending a congestion event cleared notification to at least one of the host and the storage array.

17. The non-transitory computer-readable medium or media of claim 15 further comprising one or more sequences of instructions which, when executed by at least one processor, causes steps to be performed comprising:
extracting, from the data, one or more of: an Internet Protocol (IP) address, Media Access Control (MAC) address, Virtual Local Area Network (VLAN) identifier, or port for the host and the storage array.

18. The non-transitory computer-readable medium or media of claim 15 further comprising one or more sequences of instructions which, when executed by at least one processor, causes steps to be performed comprising:
sending a congestion event notification to one or more members of the identified zones.

19. The non-transitory computer-readable medium or media of claim 15 wherein the congestion event notification or a subsequent message related to the congestion event notification includes one or more identifiers that identifies a source of the congestion event.

20. The non-transitory computer-readable medium or media of claim 15 wherein the step of correlating at least one of the one or more identifiers to any zones comprises:
correlating at least one of the one or more identifiers to a non-volatile memory express (NVMe) qualified name (NON) of a member of a zone.
